(19) United States
(12) Patent Application Publication
(10) Pub. No.: US 2026/0058922 A1
(43) Pub. Date: Feb. 26, 2026

(54) PACKET BUFFER MANAGER

(71) Applicant: Eridu Corporation, Saratoga, CA (US)

(72) Inventor: Helia Naemi, Saratoga, CA (US)

(73) Assignee: Eridu Corporation, Saratoga, CA (US)

(21) Appl. No.: 19/307,208

(22) Filed: Aug. 22, 2025

Related U.S. Application Data
(60) Provisional application No. 63/686,139, filed on Aug. 22, 2024.

(51) Int. Cl. H04L 49/9005; H04L 49/901

(52) U.S. Cl. CPC H04L 49/9005; H04L 49/901

(57) ABSTRACT

Consistent with the present disclosure, a switch is provided that has a memory which temporarily stores packets to be selectively directed toward one or more destination egress ports. A method and apparatus are disclosed for efficiently managing the memory to support high data rate throughput by parallel processing and distributing memory management tasks across multiple packet buffer manager circuits. In one example, the apparatus includes a memory system divided into portions, with each portion managed by individual packet buffer managers operating in parallel. The packet buffer managers maintain a first plurality of memory addresses as a dedicated free list for storing incoming packets. As the free list of a particular packet buffer manager drops below a certain threshold, a weighted randomizer circuit adjusts the allocation of memory addresses among other packet buffer managers based calculated weights, which are inversely related to the number of memory addresses available to receive packets.

This application claims the benefit of Provisional Patent Application No. 63/686,139, filed on Aug. 22, 2024, the entire contents of which are incorporated by reference herein.

### BACKGROUND

The present disclosure is directed toward a data switch, which, in one example, receives packets at a plurality of ingress ports and outputs each packet at one or more egress ports.

### SUMMARY

Consistent with the present disclosure, an apparatus, such as a switch, is provided that includes a plurality of packet buffer manager circuits configured to operate in parallel, and a weighted randomizer circuit operatively connected to each packet buffer manager. A memory is also provided that includes a first plurality of memory addresses associated with a dedicated free list and a second plurality of memory locations associated with a shared free list, wherein the weighted randomizer circuit is configured to adjust allocation of packet storage locations between the first memory addresses dedicated free list and the shared free list based on weighted probabilities corresponding to each packet buffer manager.

### BRIEF DESCRIPTION OF THE DRAWINGS

FIG. 1 shows a switch consistent with an aspect of the present disclosure;

FIG. 2 shows additional details of the switch shown in FIG. 1;

FIG. 3 shows further details of the switch shown in FIG. 1;

FIG. 4 shows locations of randomizer circuits in a switch consistent with an aspect of the present disclosure; and

FIG. 5 shows shared free list and pointer circuitry consistent with a further aspect of the present disclosure.

### DETAILED DESCRIPTION

The following detailed description of example implementations refers to the accompanying drawings. The same reference numbers in different drawings may identify the same or similar elements.

Packet switches, for example, often include a memory, which temporarily stores incoming packets received from a plurality of ingress ports. The stored packets are then selectively output from the memory and supplies to one or more desired egress ports, thereby facilitating switching of each packet. Packet buffers (PB) are often employed to regulate data throughput through the switch and to handle large volumes of network traffic. As network data arrives, each packet must be dynamically assigned to a non-predictable location within this memory system, a task performed by a packet buffer manager (PBM), which allocates memory addresses to the incoming packets, deallocates addresses for outgoing packets, and tracks free and allocated memory addresses, typically managed through a linked list, such that packets stored in non-adjacent or fragmented locations may be readily output. Free lists include addresses of buffer memory locations available for storing incoming packets. Allocated lists includes addresses of buffer memory locations that currently store packets pending output through an egress pipe or port.

However, the serialized nature of address assignments and the release process becomes a significant bottleneck for switches operating at high bandwidths. For instance, a device handling one petabit per second throughput with an average packet size of 512 bytes requires the PBM to perform 256 billion operations per second. Traditional serial processing methods may be insufficient to meet such high-performance demands.

Moreover, running multiple PBMs in parallel for scalability leads to the partitioning of the packet buffer into multiple smaller sections. Such partitioning restricts the elasticity required to absorb network data bursts, as each PBM can only manage a fraction of the memory, greatly limiting the amount of traffic burst the PBM can handle.

Moreover, each PBM engine may be required to maintain a structure capable of mapping the entire PB, leading to a significant overhead and complexity in the memory management system. Current systems must balance conflicting requirements of high throughput, low latency, and efficient memory utilization. Conventional clock frequencies, however, are insufficient to support such requirements. There is a need, therefore, for efficient PBMs without increasing hardware complexity.

Some implementations described herein provide an apparatus for efficiently managing memory in high-throughput network devices, such as switches, by parallel processing and distributing memory management tasks across multiple PBMs. For example, the apparatus includes a memory system divided into portions, with each portion managed by individual PBMs operating in parallel. The PBMs maintain a first plurality of memory addresses as a dedicated free list for storing incoming packets. As the free list of a particular PBM drops below a certain threshold, a weighted randomizer circuit adjusts the allocation of memory addresses by providing different weights to both the PBMs and additional secondary memories or addresses, thereby dynamically assigning memory locations among the PBMs.

In some aspects, the apparatus further includes a second plurality of memory addresses as a shared free list that complements the dedicated free lists, allowing for dynamic capacity sharing among different PBM engines. This shared free list may prevent data overflow by providing additional memory space from the shared memory pool when a PBM engine nears its free list capacity limit. Additionally, the weights allocated by the randomizer are inversely related to the size of each PBM's free list and are directly related to the allocated list size. The randomizer thus ensures the seamless distribution of memory addresses as packets egress. In addition, the randomizer optimizes memory allocation and ensures a dynamic response to varying network demands.

Accordingly, conventional serialized task handling is replaced with a distributed and scalable management system. The conversion of serialized memory management to parallel processes enables simultaneous handling of multiple memory management tasks, which increases throughput and reduces latency in memory operations. Through the utilization of the weighted randomizer circuit, the system adapts to real-time network traffic variations by dynamically adjusting memory allocation across PBMs, thereby managing memory resources more efficiently.

Allocation of memory addresses to packets via a weighted random process serves to prevent contention and bottlenecks and facilitates consistent high-speed packet buffering. Moreover, the shared free list mechanism enables the flexible deployment of memory resources, ensuring that system performance is not degraded under conditions of uneven or bursty network traffic.

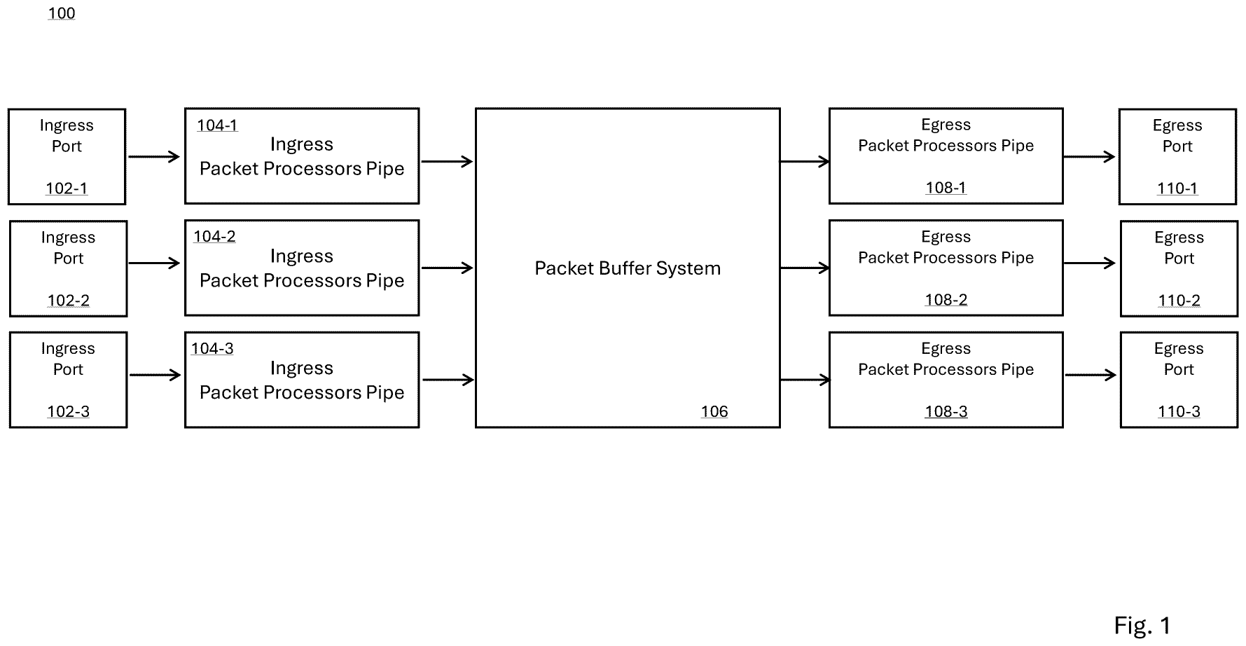

FIG. 1 depicts a high-level diagram of a switch 100 that includes multiple ingress ports 102-1, 102-2, 102-3 and egress ports 110-1, 110-2, 110-3. The switch 100 incorporates an ingress packet processor pipeline circuitry 104-1, 104-2, 104-3, and egress packet processor pipeline circuitry 108-1, 108-2, 108-3. The ingress (104) and egress (108) circuitry are both operatively connected to a packet buffer system 106.

Operation of switch 100 will next be generally described. Each of ingress ports 102-1 to 102-3 provides packets to corresponding ingress packet processor pipeline circuitry 104-1 to 104-3, each of which processes the header of a received packet. In one example, each of circuits 104-1 to 104-3 includes a series of packet processing stages arranged in sequence, with each stage completing a part of the overall processing of packet headers and passing intermediate results to the next stage. This approach allows for multiple stages to operate simultaneously on different packets, thereby increasing processing efficiency and throughput.

Circuits 104-1 to 104-3 next output the processed packets to packet buffer system 106, which includes a shared memory. The packets are written to or stored in locations in such as a memory, based at least in part on the header information obtained from the circuits 104. In one example, packet buffer system 106 serves as a buffer memory for traffic queues of packets before the packets are scheduled to be output by way of a designated egress port 110. Preferably, the memory has elasticity to absorb bursts of data and flexibility to send packets output from one or more of egress ports 110-3.

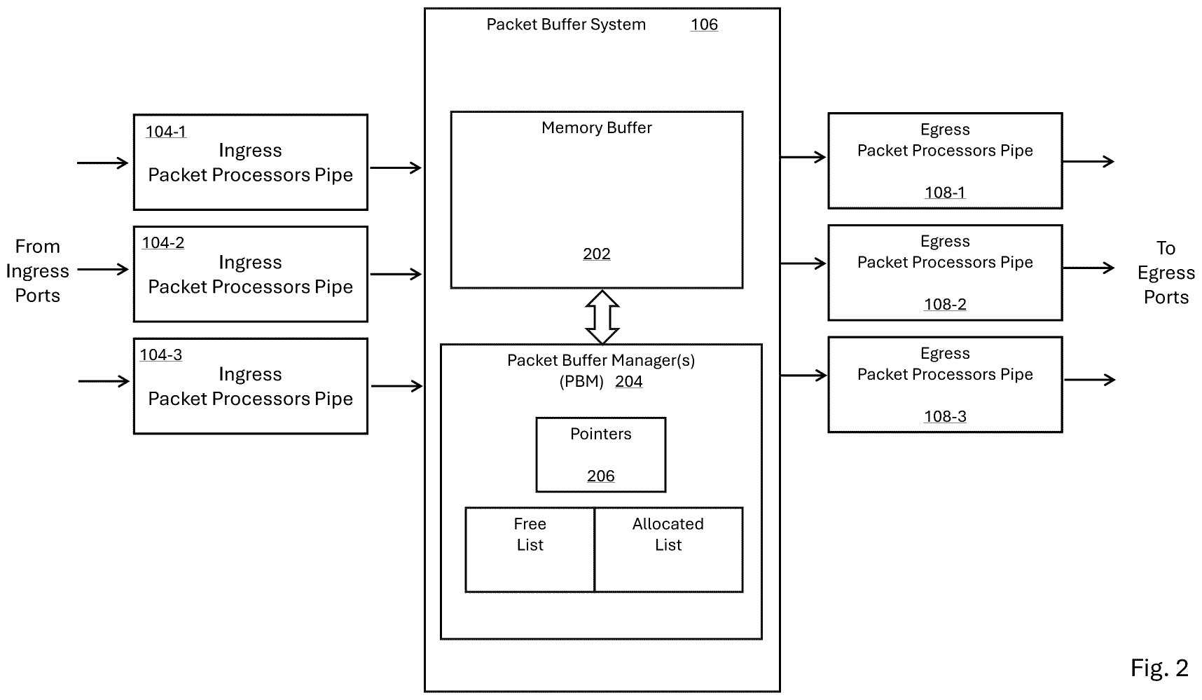

In one example shown in FIG. 2, packets input to one of ingress ports 102 may be selectively output from a corresponding one of egress ports 110, to thereby realize a packet switching function. PBM 204 and a list system controlled by pointers 206 track memory addresses in allocated and free list buffers. The PBMs 204 receive data from the ingress packet processor pipes 104-1, 104-2, 104-3, manage the memory address allocation for ingress packets, and pass processed data to the outgoing packet streams through egress packet processor pipes 108-1, 108-2, 108-3.

As further shown in FIG. 2, packet buffer system 106 includes memory buffer 202, implemented as a static random access memory (SRAM), for example, and one or more packet buffer manager circuits 204, which manage allocation of spaces or locations in memory buffer 202. Namely, packet buffer manager circuit 204 allocates locations in memory buffer 202 for storing packets input from a corresponding ingress packet processing circuit 104. In addition, as packets are output from memory buffer 202, locations are freed up or made available for an input packet from ingress packet processor pipeline circuitry 104. Moreover, the packet buffer manager circuit 204 keeps track of the addresses associated with allocated and free locations by maintaining allocated and free lists, respectively, as described in greater detail below.

Typically, as packets are input to and output from memory buffer 202, the allocated memory locations become fragmented, such that incoming packets cannot be stored in consecutive locations or segments in the memory. Accordingly, a linked list may be used that includes addresses of allocated and available or free memory locations in buffer 202. As generally understood, a linked list is a linear collection of data elements whose order is not given by their physical placement in memory. Instead, each element points to the next. In a further example, each element of the list contains data, and a reference or to the next element in the sequence.

In one example, packet buffer manager 204 operates at the same rate that packets are input to and output from memory buffer 202. Accordingly, if, for example, switch 100 has a throughput of 1 petabit per second (Pbps) and the average packet size is 512 bytes (B), the packet buffer manager 204 preferably operates at 256 gigapackets per second (GPPS). In another example, if switch 100 has a throughput of 256 terabits per second (Tbps) and the average packet size is 512 B, the packet buffer manager 204 operates at 64 GPPS.

A system clock by which operations of switch 100 are synchronized typically operates at a rate less than the above packet rates. For example, the clock rate may be approximately 2 GHz. Therefore, multiple packet buffer managers 204 may be provided that operate in parallel so that the above switch throughput rate may be obtained. In one example, a relatively large number of packet buffer managers, such as 128 such packet buffer managers, may be provided.

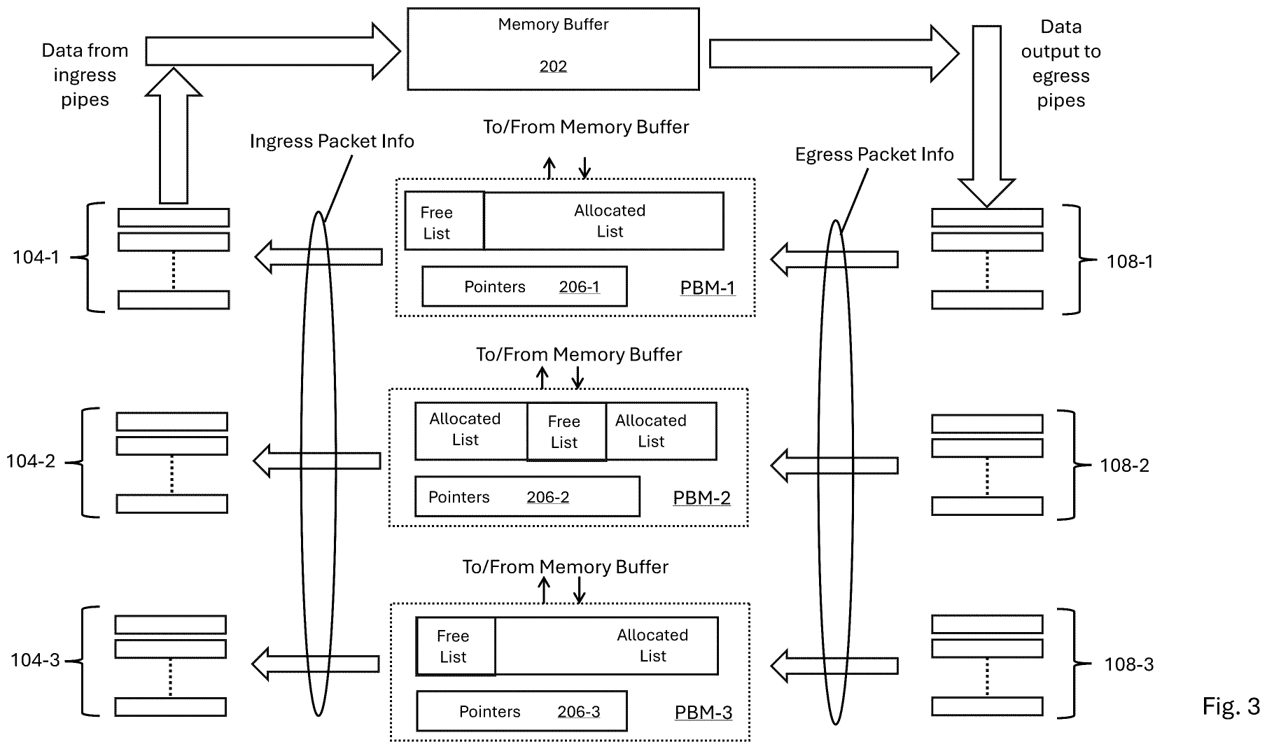

FIG. 3 illustrates an example of a switch that includes multiple ingress pipes, denoted as 104-1, 104-2, and 104-3, which provide data to the system. These ingress pipes transfer packets to a central memory buffer 202, which serves as an intermediary storage location for the packets.

As further shown in FIG. 3, the switch includes PBMs, identified as PBM-1, PBM-2, and PBM-3, with associated pointers 206-1, 206-2, and 206-3, respectively. Each PBM has an associated free list of memory locations or addresses, an allocated list of memory locations or addresses, and pointers. The free list includes memory addresses that are currently unoccupied and can be allocated to incoming packets. The allocated list tracks the memory addresses that have been assigned to packets currently stored within the memory buffer 202. The pointers include information that supports provide the means to navigate between the Free List and Allocated List within each PBM, coordinating the flow of packets and their corresponding memory addresses.

Data from the ingress pipes is directed to the Memory Buffer 202, which is managed by the respective PBMs. Specifically, ingress packet data channeled through ingress pipe 104-1 is managed by PBM-1, data via ingress pipe 104-2 by PBM-2, and data via ingress pipe 104-3 by PBM-3. Post-processing and storage within memory buffer 202, packets are routed to egress pipes, labeled as 108-1, 108-2, and 108-3, corresponding to data outputs from PBM-1, PBM-2, and PBM-3, respectively.

FIG. 3 illustrates an apparatus where packet buffer managers PBM-1, PBM-2, and PBM-3 operate independently of one another to manage dedicated free lists and allocated lists associated with each PBM. Each PBM 204 includes pointers 206-1, 206-2, 206-3 which track memory addresses in both the dedicated free list and the corresponding allocated list. Although the configuration shown in FIG. 3 is relatively easy to implement, each packet buffer has limited capacity and may therefore be subject to overflow in the event of a data burst.

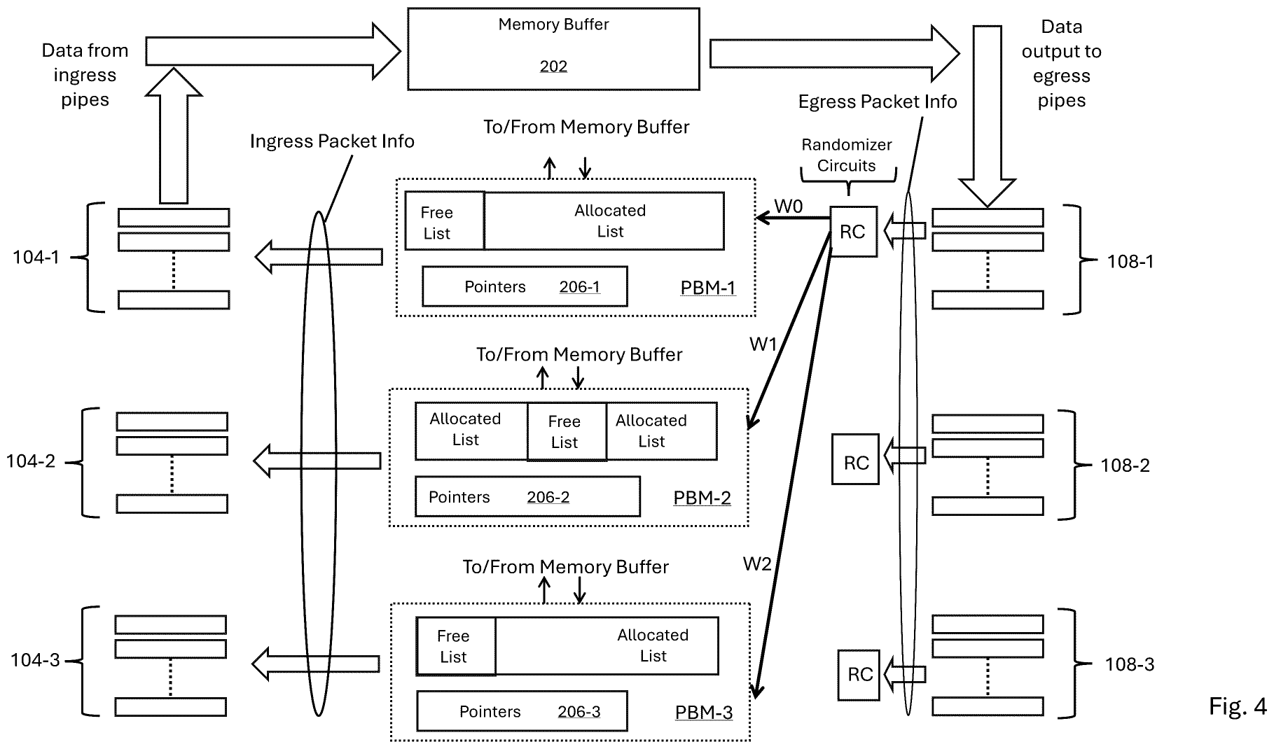

FIG. 4 illustrates a switch consistent with an aspect of the present disclosure. The switch shown in FIG. 4 includes dynamic memory address allocation for efficient data throughput and data overflow mitigation. The switch shown in FIG. 4 is similar to that shown in FIG. 3. For example, the switch shown in both figures includes ingress pipes 104-1, 104-2, and 104-3 that receive incoming packets and egress pipes 108-1, 108-2, and 108-3 for data packet output. The switch shown in FIG. 4, however, further includes randomizer circuits (RC) associated with egress pipe 108-1 to 108-3, respectively. Randomizer circuits RS, in one example, dynamically distribute memory addresses cleared by the egress pipes across the PBMs using a weighted randomization algorithm. This allows each PBM to flexibly utilize the overall memory space, efficiently managing variable network traffic loads based on an algorithm. Namely, the algorithm assigns a weight (W0, W1, W2) to a corresponding PBM, such that PBMs having weights with a relatively high value have more free memory locations associated therewith and thus can assign or allocate incoming packets to more memory locations than PBMs having weights with relatively low values. In other words, higher weights are assigned to PBMs with more allocated memory to thereby balance memory allocation across the system. Moreover, the algorithm calculates weights based on the size of the free list and the size of the allocated list associated with each PBM, whereby a high weight is associated with a low free list size/high allocated list size, and a low weight is associated with a low free list size/high allocated list size. Thus, the weights are adjustable and inversely related to the size of the free list to thereby efficiently redistributing memory addresses among the PBMs using a probability algorithm. The randomizer circuits RC, each with corresponding weights W0, W1, W2, allocate or release memory addresses to the dedicated or shared free list based on weighted probabilities corresponding to the PBMs.

Accordingly, in FIG. 4, packet buffer capacity may therefore be shared among multiple PBMs. In addition, the switch shown in FIG. 4 may be relatively simple to design.

It is noted that FIG. 4 is provided as an example. Other examples may differ from what is described with regard to FIG. 4. The number and arrangement of components shown in FIG. 4 are provided as an example. In practice, there may be additional components, fewer components, different components, or differently arranged components than those shown in FIG. 4.

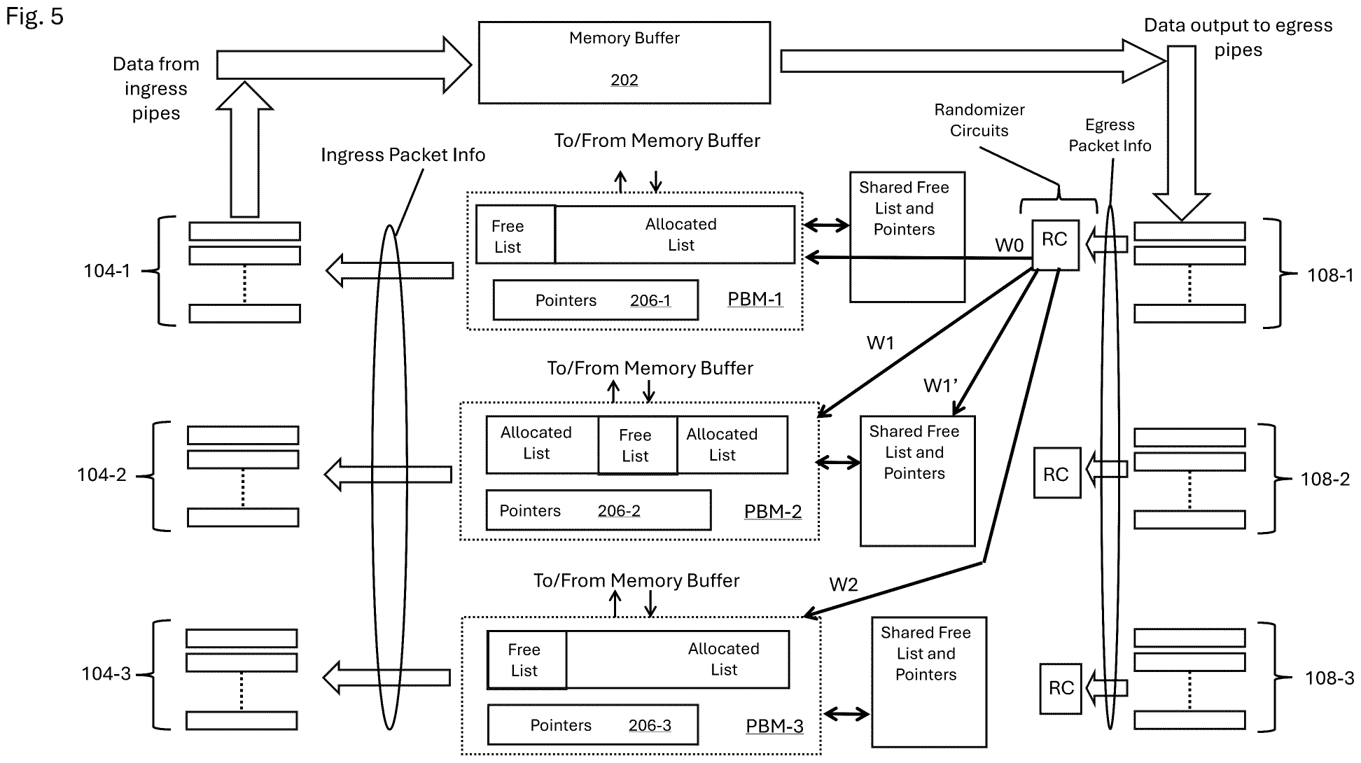

FIG. 5 shows a further example consistent with the present disclosure that is similar to the example shown in FIG. 4. The example shown in FIG. 5, however, further includes memories for storing shared free list pointers. Although in one example, the number of such shared free list pointer memories is the same as the number of PBMs, the number of such memories, as well as the number of such pointers may be different than the number of PBMs. Each set of shared free list pointers is not assigned or dedicated to any particular pointer, unlike pointers 206. Accordingly, such shared free list pointers are available as additional pointers in the dedicated PBMs, such as pointers 206.

Alternatively, the shared free list pointers may be available as additional free list pointers associated another set of free list pointers.

Accordingly, if a dedicated free list associated with a particular PBM has a low number of free or available free packet buffer addresses due to a high number of received packets, a free list from the shared free list pool may be assigned to the corresponding PBM associated with a high number of allocated memory addresses.

Shared free list pointers may continue to be assigned to a particular PBM so long as the allocated list remains high, i.e., has a relatively large number of allocated memory addresses. In a further example, the shared free list may be speculatively assigned to a PBM based on anticipated or predicted data traffic. In addition, there may be a delay or hysteresis in reassigning a shared free list pointers. Such hysteresis may assist in transitioning to another PBM.

In the example shown in FIG. 5, each packet buffer is accessible by each egress port such that high throughput may be realized.

Consistent with a further aspect of the present disclosure, each ingress packet processing pipe is assigned to a PBM and sends a memory allocation request to that PBM. Once the packet is egressed from the destination port, the memory segment is released. In a further example, the PBM is partitioned into a plurality (M) segments, and two ingress pipes send to one egress pipe. The number of egress pipes, therefore, is limited to 2/M. The above-described apparatus and method may be provided to increase throughput through a switch with such a limited number of egress pipes.

Overall, the apparatus provides an efficient solution for memory address allocation and management for both ingress and egress packets, optimizing traffic flow within network devices that handle extremely high volumes of data.

As indicated above, FIGS. 1-5 are provided as an example. Other examples may differ from what is described with regard to FIGS. 1-5.

The foregoing disclosure provides illustration and description but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A switch comprising:
a plurality of packet buffers, each of which being operable to store packets;
a plurality of packet buffer manager circuits coupled to the plurality of packet buffers;
a weighted randomizer circuit operatively connected to each packet buffer manager; and
a memory including a dedicated free list and a shared free list,
wherein the weighted randomizer circuit is configured to adjust allocation of memory addresses between the dedicated free list and the shared free list based on weighted probabilities corresponding to each packet buffer manager, the memory addresses being associated with addresses in the plurality of packet buffers.

2. The switch of claim 1, wherein the packet buffer managers are configured to manage allocation of memory addresses for ingress and egress packets in the network device.

3. The switch of claim 1, wherein the memory further comprises pointers configured to track memory addresses in the dedicated free list and the shared free list.

4. The switch of claim 1, wherein each packet buffer manager includes a dedicated free list and is configured to request additional memory space from the shared free list upon reaching a threshold of memory capacity.

5. The switch of claim 1, wherein each packet buffer manager is further configured to release memory addresses back to the dedicated free list and the shared free list for recycling by the weighted randomizer circuit.

6. The switch of claim 1, wherein the shared free list is dynamic and extendable based on demand from the packet buffer managers.

7. The switch of claim 1, wherein the weighted randomizer circuit includes a plurality of weights, each weight corresponding to one of the packet buffer managers, and each weight being adjustable based on available capacity in associated dedicated free lists.

8. The switch of claim 7, wherein the weights are configured to be inversely related to the size of the free list and directly related to the size of the allocated list of each packet buffer manager.

9. The switch of claim 1, wherein the weighted randomizer circuit is configured to distribute memory addresses among the packet buffer managers based on a probability.

10. The switch of claim 1, further comprising a memory buffer system configured to store packets and operate at a frequency of at least 2 gigahertz.

11. The switch of claim 10, wherein the memory buffer system is comprised of a plurality of memory segments, each managed by a respective packet buffer manager.

12. The switch of claim 1, wherein the weighted randomizer circuit comprises a hardware component within the network device.

13. The switch of claim 1, wherein the switch comprises a plurality of ingress and egress ports communicatively connected to the packet buffer managers.

14. The switch of claim 13, wherein the switch is configured to dynamically allocate shared memory to buffer ingress packets based on egress pipeline demands.

15. The switch of claim 1, wherein the memory further comprises pointers differentiated by pointers for the dedicated free list and pointers for the shared free list.

16. The switch of claim 6, wherein the dedicated free list is initially configured to store a pre-determined number of memory addresses before dynamic allocation from the shared free list is initiated.

17. The switch of claim 1, further comprising a plurality of egress packet processors coupled to the packet buffer managers and configured to process packets.

18. The switch of claim 1, wherein the weighted randomizer circuit includes a functional interface to receive operational parameters for the probability distribution of memory addresses.

19. The switch of claim 1, wherein the weighted randomizer circuit is configured to provide an approximation of memory address allocation to maintain high throughput performance without requiring constant updates for each change in memory lists.
